(19) United States
(12) Patent Application Publication
(10) Pub. No.: US 2024/0419645 A1
(43) Pub. Date: Dec. 19, 2024

(54) LARGE OBJECT DATA IN A DATABASE SYSTEM

(71) Applicant: INTERNATIONAL BUSINESS MACHINES CORPORATION, ARMONK, NY (US)

(72) Inventors: Reinhold Geiselhart, Rottenburg-Ergenzingen (DE); Max Fabian Gilbert, Ludwigshafen am Rhein (DE); Felix Beier, Haigerloch (DE); Knut Stolze, Hummelshain (DE)

(21) Appl. No.: 18/462,757

(22) Filed: Sep. 7, 2023

(30) Foreign Application Priority Data
Jun. 15, 2023 (GB) 2308929.5

(51) Int. Cl. G06F 16/22; G06F 16/27

(52) U.S. Cl. CPC G06F 16/2219; G06F 16/221; G06F 16/27

(57) ABSTRACT

A method for storing data in a table of a database system is disclosed. The table comprises a first column and a second column. The first column is configured for comprising first type data. The second column is configured for comprising second type data, wherein the second type data has a maximum size higher than a maximum size of the first type data. The method comprises: receiving a query to store a record in the table. It may be determined whether the record comprises a value of the second column. In case the record comprises the value of the second column, the value may be stored in a version control system and a reference token representing the value may be stored in the second column of the table. In case the record does not comprise the value of the second column, the record may be stored in the table.

### BACKGROUND

The present disclosure relates to the field of digital computer systems, and more specifically, to a method for storing data in a table of a database system.

Large Objects (LOBs) may be a set of data types that are designed to hold large amounts of data. For example, a LOB can hold up to a few terabytes depending on the database configuration. However, the storage of LOBs may be a challenging task.

### SUMMARY

Various embodiments provide a method for storing data in a table in a database system, computer program product and database system as described herein. Advantageous embodiments are described in the following description. Embodiments of the present disclosure can be freely combined with each other if they are not mutually exclusive.

In one aspect, the disclosure relates to a method for storing data in a table of a database system, the table comprising a first column and a second column, the first column being configured for comprising first type of data, the second column being configured for comprising second type of data, wherein the second type of data has a maximum size higher than a maximum size of the first type of data. The method comprises: providing a version control system; receiving a query to store a record in the table; determining whether the record comprises a value of the second column; in case the record comprises the value of the second column, storing the value in the version control system and obtaining a reference token representing the value; storing the reference token in the second column of the table; in case the record does not comprise a value of the second column, storing the record in the table.

In one aspect the disclosure relates to a computer program product comprising a computer-readable storage medium having computer-readable program code embodied therewith, the computer-readable program code configured to implement the method of the above embodiment.

In one aspect the disclosure relates to a database system for storing data in a table of the database system, the table comprising a first column and a second column, the first column being configured for comprising first type data, the second column being configured for comprising second type data, wherein the second type data has a maximum size higher than a maximum size of the first type data. The database system is configured for: receiving a query to store a record in the table; determining whether the record comprises a value of the second column; in case the record comprises the value of the second column, storing the value in a version control system and obtaining a reference token representing the value; storing the reference token in the second column of the table; in case the record does not comprise a value of the second column, storing the record in the table.

### BRIEF DESCRIPTION OF THE DRAWINGS

In the following embodiments of the disclosure are explained in greater detail, by way of example only, making reference to the drawings in which:

FIG. 1A illustrates a diagram of a data analysis system in accordance with an example of the present subject matter.

FIG. 1B depicts a data layout of a source table in accordance with an example of the present subject matter.

FIG. 2 is a flowchart of a method for storing data in a table in accordance with an example of the present subject matter.

FIG. 3 is a flowchart of a method for reading data from a table in accordance with an example of the present subject matter.

FIG. 4 is a flowchart of a method for deleting data from a table in accordance with an example of the present subject matter.

FIG. 5 illustrates a diagram of a database system in accordance with an example of the present subject matter.

FIG. 6 is a flowchart of a method for storing data in a table in accordance with an example of the present subject matter.

FIG. 7 is a flowchart of a method for reading data from a table in accordance with an example of the present subject matter.

FIG. 8 illustrates a diagram of a data analysis system in accordance with an example of the present subject matter.

FIG. 9 is a block diagram illustrating a method for logging changes in a data analysis system in accordance with an example of the present subject matter.

FIG. 10 is a computing environment according to an example of the present subject matter.

### DETAILED DESCRIPTION

The descriptions of the various embodiments of the present disclosure will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A database system (S_{DB}) may be provided. The database system S_{DB} may be configured to store data and enable access to the stored data. The database system S_{DB} may comprise a physical space for storing the data. For example, the physical space may be provided as a table space. The table space may represent a storage location where the actual data underlying database objects of the database system may be kept. The database object which occupies physical space may be table data and indexes. The physical space may be a set of volumes on disks that hold the data.

The present subject matter may enable an efficient storage of data in a table (T₀) of the database system S_{DB}. The table T₀ may comprise a set of N1 first columns and a set of N2 second columns, where N1 is the number of first columns which is higher than or equal to one, N1≥1 and N2 is the number of second columns which is higher than or equal to one, N2≥1. The first columns represent first attributes respectively. The first attributes may be of a first data type. The first data type may comprise a regular data type such as INTEGER type, CHAR type etc. The first attributes may, for example, comprise an ID attribute, a name attribute, an age attribute etc. The second columns represent second attributes respectively. The second attributes may be of a second data type. The second data type may comprise a large object (LOB) data type such as BLOB type, CLOB type, NCLOB type, BFILE type etc. The second attributes may, for example, comprise a video file, image, graphic etc. The first columns may thus be referred to as regular columns and the second columns may be referred to as LOB columns. The values of the first attributes may be referred to as regular values and the values of the second attributes may be referred to as LOB values. Thus, the table T₀ may comprise rows (or records), wherein each row has N1+N2 values of the N1 first columns and of the N2 second columns respectively.

The first data type is different from the second data type. The second data type may have a maximum size higher than a maximum size of the first type data. For example, a LOB type can store up to 4 GB of data or more while a CHAR type may store up to e.g., to 1 GB of data; meaning that the LOB type (second data type) in this example has a maximum size of 4 GB and the CHAR type (first data type) has a maximum size of 1 GB.

The present subject matter may provide an efficient method for managing access to the table T₀. For that, a version control system (VCS) may be used in addition to the database system S_{DB}. The version control system may or may not be part of the database system S_{DB}. In order to store a record (named new record R₀) in the table T₀, it may be determined whether the new record R₀ has one or more values of respective one or more second attributes of the N2 second attributes. For example, a query (Q₀) may be sent by a requester to store the new record R₀ in the table T₀. In case the new record R₀ has one or more values of the second attributes respectively, said one or more values may be stored in the version control system. In addition, reference tokens which represent respectively said one or more values may be stored in the table T₀ in association with any regular value of the first attributes which is part of the new record. For example, if the new record R₀ has LOB values LOBᵥₐₗ¹ . . . LOBᵥₐₗ^{N2} and regular values REGᵥₐₗ¹ . . . REGᵥₐₗ^{N1}, then the record defined by values: “REGᵥₐₗ¹ . . . REGᵥₐₗ^{N1} . . . TOKᵥₐₗ¹ . . . TOKᵥₐₗ^{N2}” may be stored in the table T₀ and the LOB values LOBᵥₐₗ¹ . . . LOBᵥₐₗ^{N2} may be stored in the version control system, where TOKᵥₐₗ¹ . . . TOKᵥₐₗ^{N2} are the reference tokens representing the LOB values LOBᵥₐₗ¹ . . . LOBᵥₐₗ^{N2} respectively. In case the new record R₀ has only regular values, then the new record may be stored in the table T₀. The reference tokens may, for example, be created and provided/returned by the version control system to the requester as keys to retrieve the corresponding LOB data from the version control system. For example, upon storing a LOB value by the version control system, the version control system automatically provides the reference token representing the stored LOB value. The reference tokens are provided by the version control system so that for a particular reference token there is only one LOB value assigned to it. The reference token may indicate one or more properties of the associated LOB value. The properties may enable the version control system to identify the LOB value using the reference token. For example, the property may include any one of: the last modification date of the LOB value, the size of the LOB value, a storage location of the LOB value, or a unique mapping of the LOB value to a smaller size value e.g., the reference token may be provided as a hash value.

In one example, in case the received query Q₀ is an update request to update a previous LOB value with a new LOB value, the previous LOB value may be copied, the new LOB value may be stored and the version control system may return the reference token that represents the new LOB value. Alternatively, the previous LOB value may be maintained and associated delta may be stored in the version control system, wherein the delta indicates the changes to be applied to the previous LOB value to obtain the new LOB value. In this case, the reference token that represents the new LOB value may be provided as the reference token that points to the stored delta.

The present subject matter may enable an efficient management of tables comprising large objects and regular objects by a modular design involving database and version control systems. The database system may manage the large objects using the version control system while the regular values may be managed by the database system.

The version control system may enable to recover current and previous versions of stored records. The version control system is configured to maintain different versions of the second column. The reference token represents a specific version of the value of the second column in the record. For example, in case the table is a student table, each record represents a distinct student, wherein the second column represents a video in which the student introduces a given subject. In addition, one student may provide different versions of the video. In this case, the version control system may store the different versions of the video of said student and may provide one reference token per version of the video.

In one example, the method further comprises: creating a logfile for logging changes of the table T₀. The change of the table T₀ may comprise a deletion of a record of the table T₀, wherein the deleted record may be referred to as delete record herein. In this case, the change is said to involve a delete record. Alternatively, the change may comprise an insertion of a record in the table T₀, wherein the inserted record may be referred to as insert record herein. In this case, the change is said to involve an insert record. Alternatively, the change may comprise an update of an existing record in the table T₀, wherein the update may comprise deletion of said existing record and insertion of its respective updated record. In this case, the change is said to involve a pair of delete record and insert record. Each log entry of the logfile may represent a change of the table T₀. The log entry of the change may comprise for each involved record in the change, one or more values of the N1 first columns of the given record and/or one or more reference tokens of the respective one or more values of the N2 second columns of the given record. For example, if the change is a deletion of a record, the log entry may comprise values of the first columns of the involved delete record and reference tokens of the values of the second columns of the involved delete record. If the change is an insertion of a record, the log entry may comprise values of the first columns of the involved insert record and reference tokens of the values of the second columns of the involved insert record. If the change is an update of an existing record, the log entry may comprise values of the first columns of the insert record and reference tokens of the values of the second columns of the insert record in addition to the values of the first columns of the delete record and reference tokens of the values of the second columns of the delete record. That is, the log entry does not comprise the LOB values.

This example may enable a logfile of smaller size while still providing the functionality of logfiles such as undoing changes, replications, recovering data etc. This may save storage resources. The logfile may, for example, be used to undo the change by reading the entry and using the reference tokens in the entry to find the corresponding LOB values which are kept by the version control system. The found values may be used to undo the change.

The database system S_{DB} may comprise a command processor that manages access to the table T₀. For example, the command processor may be configured to receive queries against the table T₀ and may execute the queries against the table T₀. For example, the command processor may be configured to return requested records of the table T₀ or change records of the table T₀. The operation of the command processor may be improved in accordance with the present subject matter by using a handler. The handler may be named source LOB handler. The source LOB handler may be a software and/or hardware module. The source LOB handler may be configured to intercept the query Q₀ which is destined to the command processor. The source LOB handler may determine whether the new record R₀ in the query Q₀ has one or more LOB values, and in case the new record R₀ has one or more LOB values, the source LOB handler may store the one or more LOB values in the version control system. The source LOB handler may retrieve the reference tokens which represent the one or more LOB values respectively from the version control system. The source LOB handler may change or rewrite the query Q₀ to replace the one or more LOB values which are in the query Q₀ by the retrieved reference tokens respectively. The changed or rewritten query may be forwarded by the source LOB handler to the command processor. The command processor may process the changed query (as usual) to store the zero or more regular values of the new record R₀ and the reference tokens in the table T₀. In case, the new record R₀ does not comprise any LOB value, the source LOB handler may forward the query Q₀ (as it is) to the command processor for execution against the table T₀. This example may enable a seamless integration of the present subject matter in existing systems preventing a significant change to the existing systems while making use of the advantage of the present subject matter.

The new record R₀ may be inserted in the table T₀. In this case, the query Q₀ may be an insert command for inserting the new record R₀ in the table T₀. The insert commands may enable to fill the table T₀ from scratch. Alternatively, the new record R₀ may be used to update an exiting record of the table T₀. In this case, the query Q₀ may be an update command for updating the existing record of the table T₀.

According to one example, the source LOB handler may intercept a read request. The read request may be a request to read one or more LOB values. The read request is destined to the command processor. In response, the source LOB handler may return to the requester the requested LOB values from the version control system. In addition, the source LOB handler may forward the read request to the command processor but in addition prevent the command processor to return the reference tokens associated the requested LOB values. The command processor may return to the requester only zero or more regular values which fulfill the read request. The source LOB handler may prevent the command processor from returning the reference tokens associated with the requested LOB values by changing the request or by sending an instruction to the command processor accordingly. This example may be advantageous as the reference tokens may not be exposed externally, and only selections of LOB values are done to address LOB data for further operations. In another example, reference tokens may be returned by the command processor to the requester for future references.

According to one example, the source LOB handler may intercept a read request to read the table. The source LOB handler may forward the read request to the command processor so that the command processor may identify records of the table T₀ that satisfy the read request. The source LOB handler may obtain from the command processor the reference tokens of the identified records. The source LOB handler may return to the requester the LOB values associated with reference tokens in the identified records. In addition, the source LOB handler may control the command processor to return to the requester the regular values in the identified records without returning the reference tokens which are in the identified records. This example may particularly be advantageous in case the keys used to read the table T₀ is one of the regular columns.

According to one example, a delete request to delete a LOB value may be intercepted by the source LOB handler. The source LOB handler may forward the delete request to the command processor so that the command processor may delete from the table T₀ the reference token that represents the LOB value to be deleted. In addition, the source LOB handler may delete the LOB value from the version control system in case a predefined deletion condition is fulfilled. Thus, when a LOB value is selected for delete, the reference token in the table T₀ is deleted, but the LOB data in the version control system may not be deleted immediately. This may be necessary to maintain data consistency for logging, replication, and crash recovery. The deletion of the LOB value from the version control system may only be done when no reference token to the LOB value is in use anymore. The deletion condition may require the completion of queries referencing the reference token that represents the LOB value to be deleted. For example, the deletion condition may be checked by scanning of any location (such as in the logfile which is used for database recovery and replication) where reference tokens are used, to find an indication, that this specific reference token is not needed anymore. This indication could be that an external backup of the whole database tables has been done. This means, that in case of a crash the external backup is loaded into the database, and then the log is “replayed” starting from that backup recovery point. Any reference token which occurs in the log only “before” that sync-point may not be needed anymore and the associated LOB can be deleted.

In one example, the database system S_{DB} is a source database system of a data analysis system. The data analysis system comprises a target database system (T_{DB}). The table T₀ is a source table of the source database system S_{DB}. The data analysis system may, for example, be a data warehousing system or master data management system. The data analysis system may enable data warehousing or master data management or another technique that uses source and target database systems, wherein the target database system comprises a target database that is configured to receive/comprise a copy of a content of a corresponding source database of the source database system. The source database system S_{DB} may, for example, be a transactional engine and the target database system T_{DB} may be an analytical engine. For example, the source database system S_{DB} may be an online transaction processing (OLTP) system and the target database system T_{DB} may be an online analytical processing (OLAP) system. The source database system S_{DB} may comprise a source dataset and the target database system T_{DB} may comprise a target dataset. The source dataset may be part of a source database and the target dataset may be part of a target database. The source dataset may comprise tables, referred to as source tables, and the target dataset may comprise corresponding target tables. The content of the source dataset may be changed by one or more database transactions. The data analysis system may be configured to synchronize the content of the source tables of the source database system with the corresponding target tables of the target database system. For example, the present method may be performed for synchronization of data in the source database system S_{DB} with data in the target database system T_{DB}. This may enable to have the same data (of the table T₀) present in the source database system S_{DB} and the target database system T_{DB}.

According to one example, the synchronization of the table T₀ with the corresponding table in the target database system T_{DB} may be performed by replicating only the content of the table T₀ to the target database system. The replication may, for example, comprise the forwarding or submission of each received change of the table that is recorded in the logfile followed by the application of the change at the target database system. This may be advantageous because the version control system is accessible by the source and target database systems and thus there may be no need to replicate also LOB values of the target database system. This may save a lot of resources such as network resources and storage resources in the target database system. In addition, no LOB data may need to be stored in the logfile for replication, only reference tokens (which are small), so the standard replication process can be used. In consequence, only reference tokens will be applied at the target side. If any query against the target side needs the LOB data for processing or retrieval, same mechanism will happen by fetching the LOB data via reference token from the version control system.

The data analysis system may comprise a replication system that is configured for replicating changes of the source table to the target table using the logfile according to the present subject matter. The replication system may use conventional techniques, such as recovery log-based replication for replicating the changes using the logfile. The replication system may, for example, be the Change Replication System. The Change Replication System may be responsible for synchronizing the data state of the target database system with the data state of the source database system.

In order to manage queries on the target database system, the present subject matter may provide another handler which may be named target LOB handler. The target LOB handler may be configured to manage access requests to the target table as described herein with the source LOB handler. For example, the target LOB handler may intercept a query referencing the target table. The target LOB handler may identify the reference tokens of the target table that satisfy the query. The target LOB handler may provide the LOB values in the version control system which are associated with the identified reference tokens. In addition, the regular values that satisfy the query may be provided from the target table.

According to one example, the template or empty representation of the table T₀ may be created as having one or more LOB columns if an initial request to create the table T₀ indicates that the size of the one or more columns of the table are indeed higher than a minimum size. If the initial request does not indicate any column having a size higher than the minimum size, the empty table may be created as regular table with regular columns only. This minimum size may be provided as a configurable parameter in the database system S_{DB} to enable controlled creation of tables in the system.

According to one example, the access to the version control system to the whole value of the second column or to a selected portion of the value may be performed using a cursor that enables traversal of portions of the value, wherein the access is a read access and/or write access. For example, an application can get LOB data from the database without having to read/transfer the complete LOB data. Instead, the previously acquired cursor of the LOB may be provided. The application uses this cursor to fetch portions of a LOB without the need to transfer a typically very large LOB via network from the database server to the application.

In one example, the update of a given LOB value in the version control system may be performed as follows. An application may request an update of the given LOB value with a new LOB value, wherein the request comprises the reference token associated with the given LOB value. The version control system receives the reference token of the given LOB value together with the command to update the given LOB value with the new LOB value. In response, the version control system may create a copy of the given LOB value, and returns to the application a new reference token of the new LOB value. The new reference token references the new LOB value, which may be stored in the database table of a new or updated table row. Alternatively, and for resource optimization, the version control system may leave the given LOB value as it is stored, but the later updates are stored only as deltas in association with the given LOB value, wherein the delta of an update indicates the change to be applied to the given LOB value to obtain a LOB value representing the update. In this case, the reference token of the given LOB value may be used to request most recent version of the LOB value. In order to compose the most recent LOB for retrieval, the version control system may start with the given LOB value, applies all delta changes associated with the given LOB value, and finally returns the resulting most recent LOB value. In another example, upon implementing the update, the version control system may return the reference tokens of the deltas of the given LOB value e.g., upon request by the application. The application may only use the reference tokens of the deltas to request LOB values. Indeed, the application itself may only be interested in the deltas (e.g., in case the delta represents an appending of a LOB value to the given LOB value), so this may save resources when the application only asks for the added pieces.

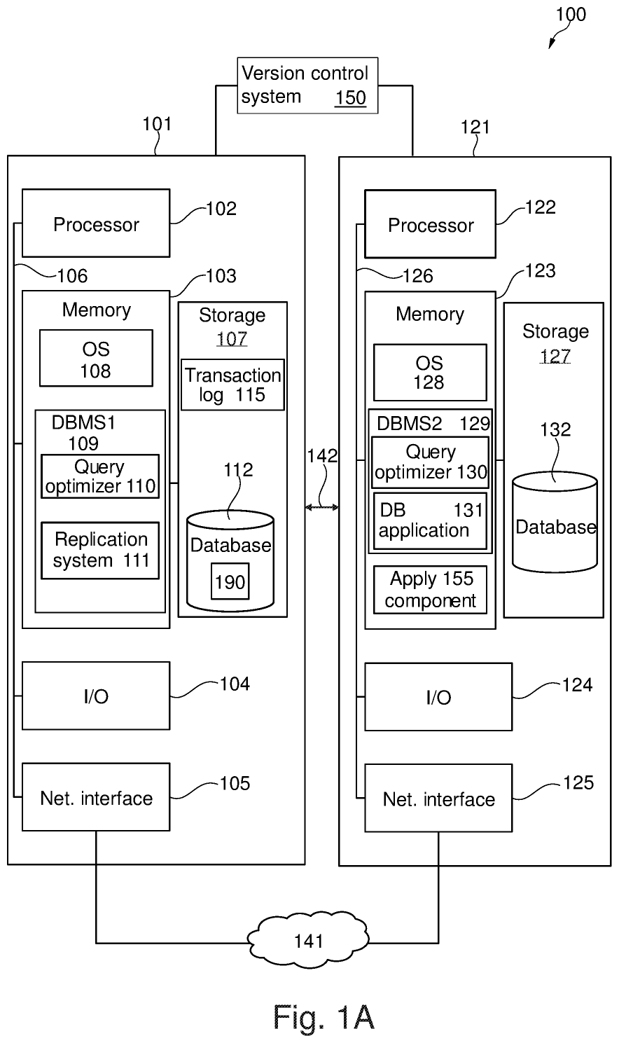

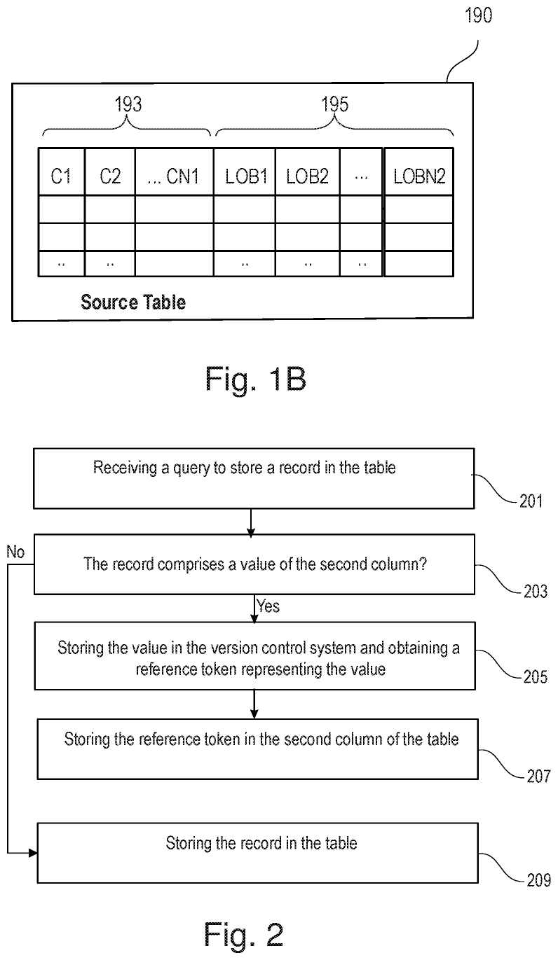

FIG. 1A is a block diagram for a data analysis system in accordance with an example of the present subject matter. The data analysis system 100 may, for example, comprise IBM Db2 Analytics Accelerator for z/OS (IDAA). The data analysis system 100 comprises a source database system 101 connected to a target database system 121. The source database system 101 may, for example, comprise IBM Db2 for z/OS. The target database system 121 may, for example, comprise IBM Db2 Warehouse (Db2 LUW).

Source database system 101 includes processor 102, memory 103, I/O circuitry 104 and network interface 105 coupled together by bus 106.

Processor 102 may represent one or more processors (e.g., microprocessors). The memory 103 can include any one or combination of volatile memory elements (e.g., random access memory (RAM, such as DRAM, SRAM, SDRAM, etc.)) and non-volatile memory elements (e.g., ROM, crasable programmable read only memory (EPROM), electronically erasable programmable read only memory (EEPROM), programmable read only memory (PROM). Note that the memory 103 can have a distributed architecture, where various components are situated remote from one another, but can be accessed by the processor 102.

Memory 103 in combination with persistent storage device 107 may be used for local data and instruction storage. Storage device 107 includes one or more persistent storage devices and media controlled by I/O circuitry 104. Storage device 107 may include magnetic, optical, magneto optical, or solid-state apparatus for digital data storage, for example, having fixed or removable media. Sample devices include hard disk drives, optical disk drives and floppy disks drives. Sample media include hard disk platters, CD-ROMs, DVD-ROMs, BD-ROMs, floppy disks, and the like. The storage 107 may comprise a first database 112. The first database 112 may, for example, comprise one or more first tables 190. FIG. 1B shows an example source table of the tables 190 as stored in the Source database system 101.

Memory 103 may include one or more separate programs e.g., database management system DBMS1 109, each of which comprises an ordered listing of executable instructions for implementing logical functions, notably functions involved in embodiments of this disclosure. The software in memory 103 shall also typically include a suitable operating system (OS) 108. The OS 108 essentially controls the execution of other computer programs for implementing at least part of methods as described herein. DBMS1 109 comprises a replication system 111 and a query optimizer 110. The replication system 111 may comprise a log reader (not shown). The log reader may read log records (also referred to as log entries) of a transaction recovery log 115 of the source database system 101 and provide changed records to the target database system 121. The usual content of a log record may comprise a timestamp, log record sequence number (LRSN) and attribute changes. More specifically, the log records in the transaction recovery log 115 may, for example, contain information defining (1) the table being changed, (2) the value of the key column in the row being changed. (3) the old and new values of all columns of the changed row, and (4) the transaction (unit of work) causing the change. By definition, an insert is a new data record and therefore has no old values. For delete changes, there is by definition no new data record, only an old data record. Thus, log records for inserted rows may contain only new column values while transaction log records for deleted rows may contain only old column values. Log records for updated rows may contain the new and old values of all row columns. The order of log records in the recovery log 115 may reflect the order of change operations of the transactions and the order of transaction commit records may reflect the order in which transactions are completed. The type of row operations in log records can, for example, be delete, insert or update. The log reader may read log records from the recovery log, extract relevant modification or change information (inserts/updates/deletes targeting tables in replication). Extracted information may be transmitted (e.g., as a request for application of the change) to target database system 121. The query optimizer 110 may be configured for generating or defining query plans for executing queries e.g., on first database 112.

Target database system 121 includes processor 122, memory 123, I/O circuitry 124 and network interface 125 coupled together by bus 126.

Processor 122 may represent one or more processors (e.g., microprocessors). The memory 123 can include any one or combination of volatile memory elements (e.g., random access memory (RAM, such as DRAM, SRAM, SDRAM, etc.)) and non-volatile memory elements (e.g., ROM, erasable programmable read only memory (EPROM), electronically erasable programmable read only memory (EEPROM), programmable read only memory (PROM). Note that the memory 123 can have a distributed architecture, where various components are situated remote from one another, but can be accessed by the processor 122.

Memory 123 in combination with persistent storage device 127 may be used for local data and instruction storage. Storage device 127 includes one or more persistent storage devices and media controlled by I/O circuitry 124. Storage device 127 may include magnetic, optical, magneto optical, or solid-state apparatus for digital data storage, for example, having fixed or removable media. Sample devices include hard disk drives, optical disk drives and floppy disks drives. Sample media include hard disk platters, CD-ROMs, DVD-ROMs, BD-ROMs, floppy disks, and the like.

Memory 123 may include one or more separate programs e.g., database management system DBMS2 129 and apply component 155, each of which comprises an ordered listing of executable instructions for implementing logical functions, notably functions involved in embodiments of this disclosure. The software in memory 123 shall also typically include a suitable OS 128. The OS 128 essentially controls the execution of other computer programs for implementing at least part of methods as described herein. DBMS2 129 comprises a DB application 131 and a query optimizer 130. The DB application 131 may be configured for processing data stored in storage device 127. The query optimizer 130 may be configured for generating or defining query plans for executing queries e.g., on a second database 132. The apply component 155 may apply received changes to the second database 132. The apply component 155 may buffer log records sent from the log reader and consolidate the changes into batches to improve efficiency when applying the modifications to the second database 132 via a bulk-load interface. This may enable to perform replication.

Source database system 101 and target database system 121 may be independent computer hardware platforms communicating through a high-speed connection 142 or a network 141 via network interfaces 105, 125. The network 141 may, for example, comprise a local area network (LAN), a general wide area network (WAN), and/or a public network (e.g., the Internet). Each of the source and target database systems 101 and 121 may be responsible for managing its own copies of the data.

Although shown in FIG. 1A as separate systems, the source and target database systems may belong to a single system e.g., sharing a same memory and processor hardware, while each of the source and target database systems is associated with a respective DBMS and datasets e.g., the two DBMSs may be stored in the shared memory. In another example, the two database management systems DBMS1 and DBMS2 may form part of a single DBMS that enables communications and method performed by DBMS1 and DBMS2 as described herein. The first and second datasets may be stored on a same storage or on separate storages.

Source database system 101 and target database system 121 may be configured to connect to a version control system 150. Only few basic capabilities may be needed, which allow the VCS 150 to be used in accordance with the present subject matter the present subject matter. Besides the ability to deal with large data, the following list contains example capabilities of the VCS 150 which may be triggered by requests from a LOB handler which is part of the source database system 101. For a LOB Insert for inserting a LOB value into the VCS 150, the LOB value may be accepted, and optionally a cursor may be opened and retrieved into a new LOB object in, where an application can “stream” the LOB value into it, a storage may be performed on a random path (no path or filename specified) and a reference token may be returned to access the LOB value later. For a LOB Retrieval for retrieving a LOB value from the VCS 150, a reference token of the LOB value may be accepted, and the LOB value may be retrieved and optionally a cursor may be opened and retrieved into referenced LOB object, by which an application can “stream” the LOB value from it. For a LOB Delete for deleting a LOB value from the VCS 150, a reference token of the LOB value may be accepted, the reference token may be invalidated (e.g., marked as deleted) and the LOB value may be deleted later (during cleanup). For LOB Update for updating a LOB value in the VCS 150, a reference token (of previous LOB version) of the LOB value may be accepted, new LOB value may be accepted, optionally a cursor may be opened and retrieved into an existing LOB object by which an application can “stream” changed LOB value into a copy of an existing LOB object, thereby creating a new version of that LOB object, a new reference token of new LOB value may be returned, old LOB value and old reference token may be kept valid and optionally a reference token for delta data (diff to previous LOB version) may be returned.

FIG. 1B depicts a diagram illustrating a source table 190 as stored in the source database system 101. The source table 190 comprises a first set of columns 193 referred to as regular columns. The source table 190 further comprises a second set of columns 195 referred to as LOB columns.

FIG. 2 is a flowchart of a method for storing data in a table in a database system in accordance with an example of the present subject matter. For the purpose of explanation, the method described in FIG. 2 may be implemented in the system illustrated in FIGS. 1A-B, but is not limited to this implementation. For example, the method of FIG. 2 may be performed by the source database system 101 for storing data in the table 190 shown in FIG. 1B.

A query to store a record in the table may be received in step 201. It may be determined in step 203 whether the record comprises a value of the second column. In case the record comprises the value of the second column, the value may be stored in step 205 in the version control system 150 and a reference token representing the value may be obtained. The reference token may be stored in step 207 in the second column of the table 190. In case the record does not comprise a value of the second column, the record may be stored in step 209 in the table 190.

In one other example of the method of FIG. 2, it may further be determined whether the value of the second column exceeds a size threshold, and in case it exceeds the size threshold it may be stored in the version control system and the associated reference token may be stored in the table; otherwise, the record including the second value and potentially value(s) of the first columns may be stored in the table.

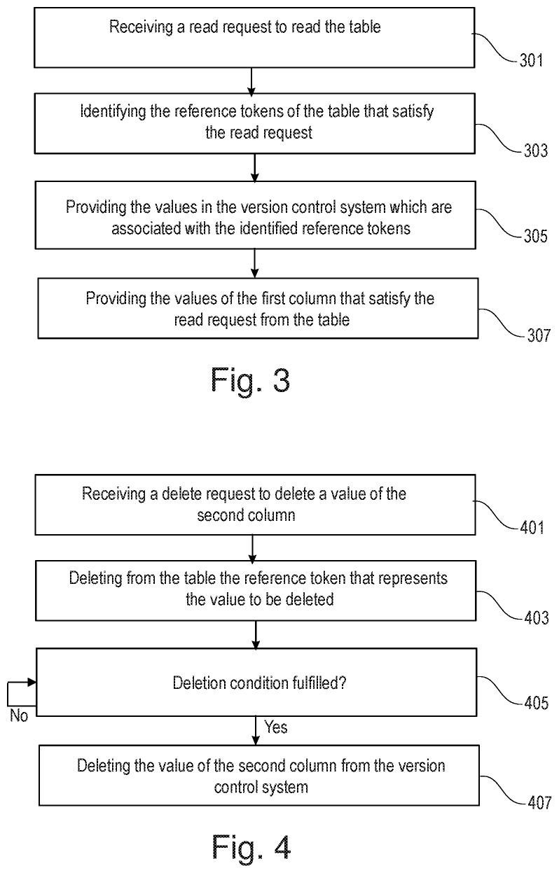

FIG. 3 is a flowchart of a method for reading a table in a database system in accordance with an example of the present subject matter. For the purpose of explanation, the method described in FIG. 3 may be implemented in the system illustrated in FIGS. 1A-B, but is not limited to this implementation. For example, the method of FIG. 3 may be performed by the source database system 101.

A read request to read the table may be received in step 301. The reference tokens of the table that satisfy the read request may be identified in step 303. The values in the version control system which are associated with the identified reference tokens may be provided in step 305. The values of the first column that satisfy the read request may be provided in step 307 from the table.

FIG. 4 is a flowchart of a method for storing a table in a database system in accordance with an example of the present subject matter. For the purpose of explanation, the method described in FIG. 4 may be implemented in the system illustrated in FIGS. 1A-B, but is not limited to this implementation. For example, the method of FIG. 4 may be performed by the source database system 101.

A delete request to delete a value of the second column may be received in step 401. The reference token that represents the value to be deleted, may be deleted in step 403 from the table. It may be determined in step 405 whether a deletion condition is fulfilled. If the deletion condition is fulfilled, the value of the second column may be deleted in step 407 from the version control system. In one example, the deletion condition may require that all queries referencing the reference token are completed.

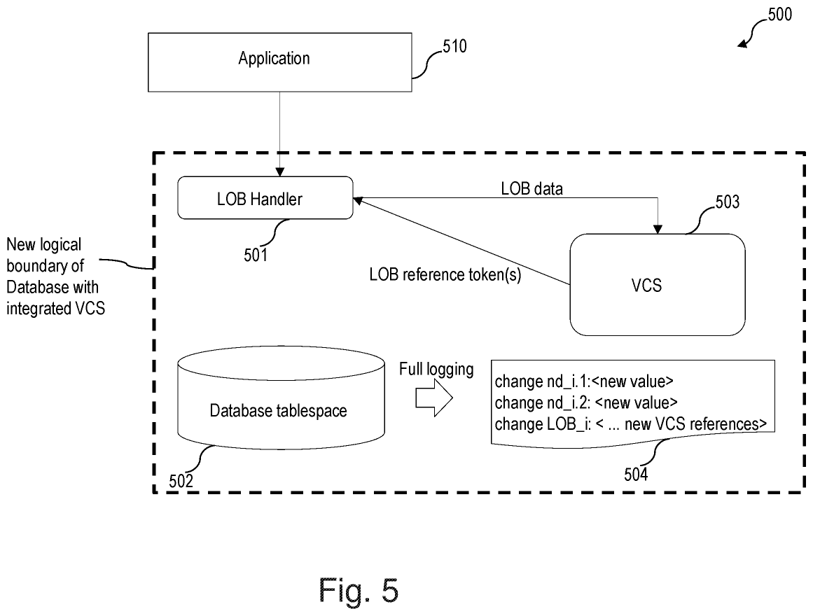

FIG. 5 is a diagram of a database system 500 in accordance with an example of the present subject matter. The database system 500 may comprise a LOB handler 501. a database 502 and a version control system 503. The version control system 503 may be relocatable. The database 502 may comprise one or more tables having LOB and regular columns. The LOB handler 501 may be configured to receive or intercept from an application 510 requests to insert or update records in the table, wherein the records may comprise LOB values and regular values. In response, the LOB handler 501 may store the LOB values in the version control system 503. In response to storing the LOB values in the version control system 503, the version control system 503 may provide LOB reference tokens which represent the stored LOB values respectively. The LOB handler 501 may then store in the database 502, the regular values and the LOB reference tokens. In addition, a log entry may be added into the logfile 504, wherein the log entry comprises the stored regular values and the LOB reference tokens. The logfile 504 may be provided with full information for (SQL) REDO and UNDO operations.

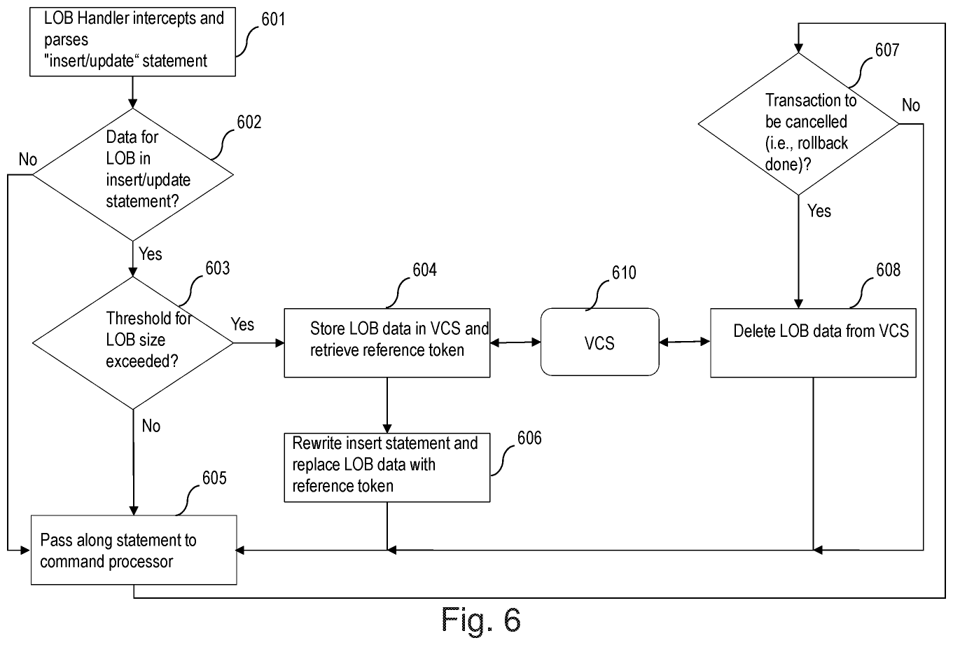

FIG. 6 is a flowchart of a method for storing data in a table in a database system in accordance with an example of the present subject matter. The LOB Handler may intercept and parse in step 601 an insert or update statement. The LOB handler may determine (602) whether the statement references a LOB value. In case the statement does not comprise any LOB value, the statement may be passed in step 605 to the database command processor in order to execute the statement against the database. In case the statement comprises a LOB value, the LOB handler may determine (603) whether the threshold for LOB size of the LOB value is exceeded. In case the threshold is not exceeded, step 605 may be performed. In case the threshold is exceeded, the LOB handler may store in step 604 the LOB value in the version control system 610 and retrieve the reference token that represents the stored LOB value. In addition, the LOB handler may rewrite in step 606 the insert statement and replace LOB data with the reference token. The rewritten statement may be passed in step 605 to the to the database command processor in order to execute the rewritten statement against the database. After executing the rewritten statement against the database, it may be determined in step 607 whether the transaction associated with the received statement is to be cancelled. In case the transaction is to be cancelled, the LOB value may be deleted in step 608 from the version control system 610.

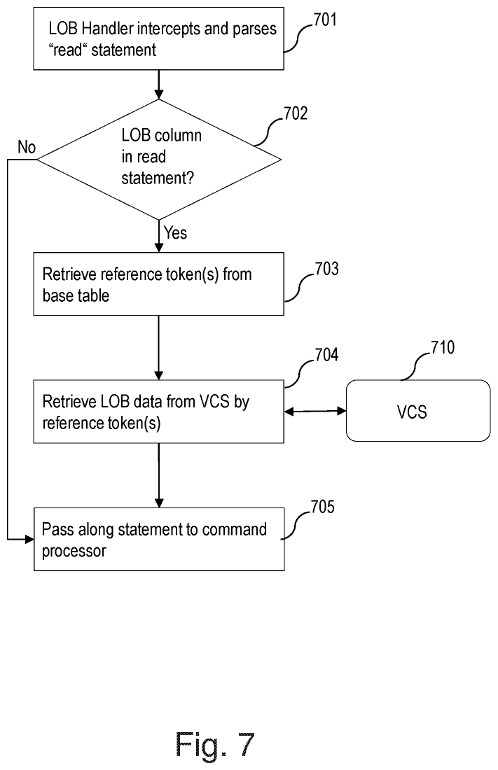

FIG. 7 is a flowchart of a method for reading a table in a database system in accordance with an example of the present subject matter. The LOB Handler may intercept and parse in step 701 a “read” statement. The LOB handler may determine (702) whether the statement reference a LOB value. In case the statement does not comprise any LOB value, the statement may be passed in step 705 to the database command processor in order to execute the statement against the database. In case the statement comprises a LOB value, the LOB handler may retrieve from the table in step 703 the reference token that represents the LOB value. The LOB handler may use the reference token to retrieve in step 704 LOB data from the version control system 710 by the reference token. After retrieving the LOB data, step 705 may be executed to retrieve the regular values from the base table.

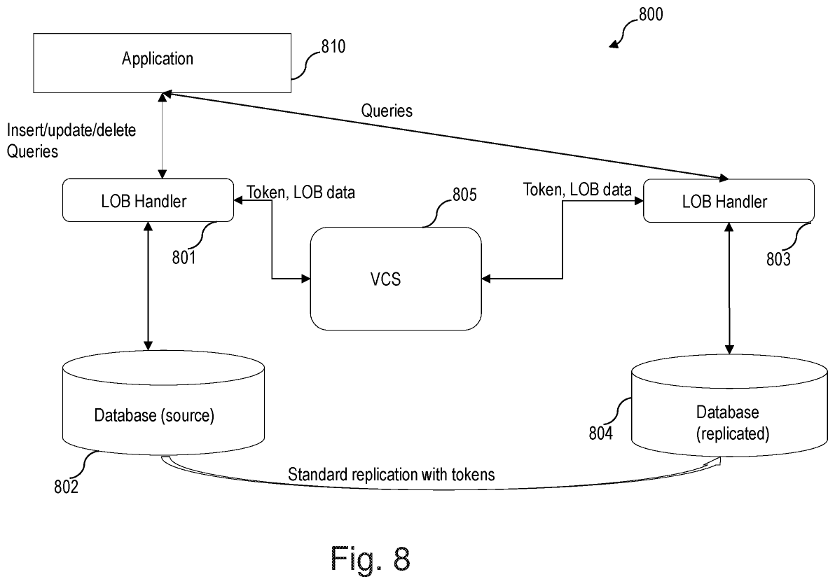

FIG. 8 is a block diagram for a data analysis system 800 in accordance with an example of the present subject matter. The data analysis system 800 comprises a source LOB handler 801 and a source database 802. The data analysis system 800 comprises a target LOB handler 83 and a target database 804. The data analysis system 800 comprises a version control system 805.

The source LOB handler 801 may be configured to receive or intercept from an application 810 requests to insert or update records in the table, wherein the records may comprise LOB values and regular values. In response, the source LOB handler 801 may store the LOB values in the version control system 805. In response to storing the LOB values in the version control system 805, the version control system 805 may provide LOB reference tokens which represent the stored LOB values respectively. The LOB handler 801 may then store in the database 802, the regular values and the LOB reference tokens. In addition, a log entry may be added into the logfile, wherein the log entry comprises the stored regular values and the LOB reference tokens. In addition, the logfile may be used to synchronize the table of the source database 802 with the corresponding table of the target database 804 so that the table in the target database 804 may have the same content as the table in the source database 802. The target LOB handler 803 may be configured to receive queries to access the table in the target database 804. For example, the target LOB handle 803 may be receive a query from the application 810 to access the table in the target database 804. In response, the target LOB handler 803 may obtain from the database 804 the regular values and the reference tokens that satisfy the query. In addition, the target LOB handler 803 may use the reference tokens to retrieve the corresponding LOB values from the version control system 805. The LOB values and the regular values may be provided by the target LOB handler 803 as a response to the query.

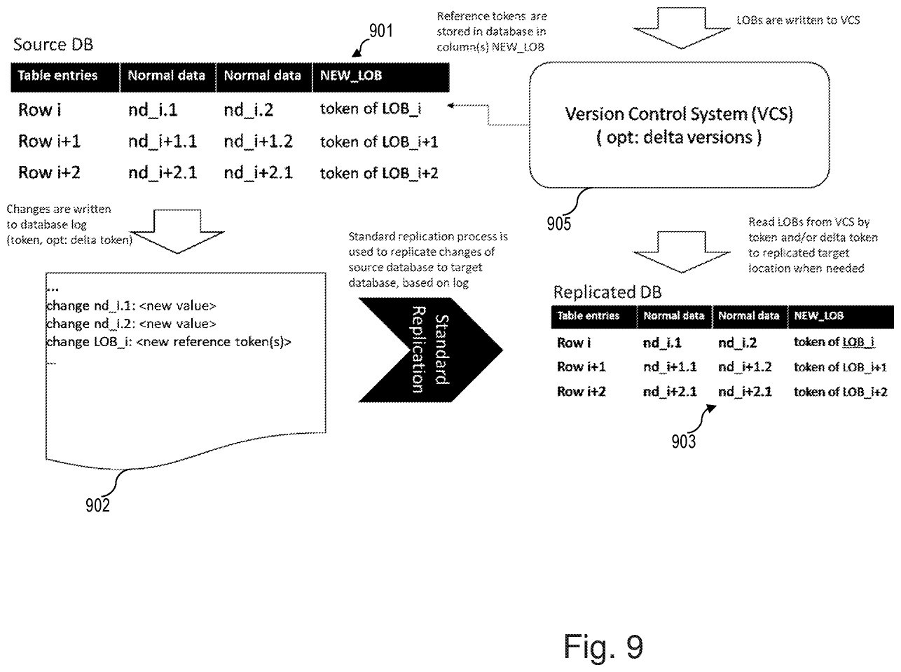

FIG. 9 is a block diagram illustrating a method for logging changes in a data analysis system (e.g., 800) in accordance with an example of the present subject matter. In this example of database replication, the standard replication process is used.

The source table 901 which comprises a LOB column comprising reference tokens and regular columns is associated with a logfile 902 which comprises changes that are applied to the source table 901. The reference tokens may represent LOB values stored in the version control system 905. The reference tokens may be obtained from the version control system 905. Each entry in the logfile 902 comprise regular values and/or reference token. Standard replication process is used to replicate changes of source database 901 to target database 903, based on the logfile 902. As indicated in FIG. 9, together with “normal” data the LOB reference tokens are sent to the target database 903. The target database 903 and VCS 905 may enable to read LOBs from VCS 905 by token and/or delta token to replicated target location when needed. When changes of the database are written to the database log 902 (for crash recovery or archival or replication), the VCS reference token (optionally: plus, the reference of the delta LOB compared to the previous version of the LOB) is/are stored as an indication, that during a transaction also the LOB data has changed. No actual LOB data may be written to the database log anymore, as with state-of-the-art approaches.

The present subject matter may comprise the following clauses.

Clause 1. A method for storing data in a table of a database system, the table comprising a first column and a second column, the first column being configured for comprising first type of data, the second column being configured for comprising second type of data, wherein the second type of data has a maximum size higher than a maximum size of the first type of data; the method comprising: providing a version control system; receiving a query to store a record in the table; determining whether the record comprises a value of the second column; in case the record comprises the value of the second column, storing the value in the version control system and obtaining a reference token representing the value; storing the reference token in the second column of the table; in case the record does not comprise a value of the second column, storing the record in the table.

Clause 2. The method of clause 1, the version control system being configured to maintain different versions of the second column, wherein the reference token represents a specific version of the value of the second column in the record, the method further comprising: creating a logfile for logging changes of the table, wherein a log entry is created in the logfile to represent a change involving at least one given record of the table, the log entry comprising a value of the first column of the at least one given record and/or the reference token of the value of the second column of the at least one given record; the at least one given record being a deleted record and/or an inserted record.

Clause 3. The method of any of the preceding clauses 1 to 2, wherein the database system is configured to manage data in the table using a command processor, wherein the query is destined to the command processor, wherein the receiving of the query comprises intercepting the query by a handler of the database system; wherein the handler is configured for performing: the determining step; and in case the query comprises the value of the second column, the storing in the version control system; the obtaining of the reference token from the version control system; changing the query to replace the value of the second column by the reference token; and forwarding the query to the command processor for execution of the query against the table.

Clause 4. The method of any of the preceding clauses 1 to 3, the database system is configured to manage data in the table using a command processor, the method further comprising: intercepting by a handler of the database system a read request of a value of the second column, the read request being destined to the command processor; preventing by the handler the command processor to return the reference token associated the requested value; returning the requested value from the version control system by the handler.

Clause 5. The method of any of the preceding clauses 1 to 4, wherein the received query is a request to insert the record in the table or a request to update another record of the table by the record.

Clause 6. The method of any of the preceding clauses 1 to 5, further comprising: receiving a read request to read the table; identifying the reference tokens of the table that satisfy the read request; providing the values in the version control system which are associated with the identified reference tokens; providing the values of the first column that satisfy the read request from the table.

Clause 7. The method of any of the preceding clauses 1 to 5, further comprising: receiving a delete request to delete a value of the second column; deleting from the table the reference token that represents the value to be deleted; and deleting the value of the second column from the version control system in case a deletion condition is fulfilled.

Clause 8. The method of clause 7, wherein the deletion condition requires that queries referencing the reference token that represents the value to be deleted are ended.

Clause 9. The method of any of the preceding clauses 1 to 8, the database system being a source database system of a data analysis system, the data analysis system comprising a target database system, wherein the target database system comprises a target table that provides a replication copy of the table, the method further comprising: synchronizing the table with the target table such that the target table comprises records of the table, wherein the record of the target table comprises the reference token and the value of the first column.

Clause 10. The method of clause 9, wherein the target database system further comprises a target handler, the target handler being configured for: intercepting a query referencing the target table; identifying the reference tokens of the target table that satisfy the query; providing the values in the version control system which are associated with the identified reference tokens; providing the values of the first column that satisfy the query from the target table.

Clause 11. The method of clause 9 or 10, wherein the version control system is remotely connected to the source and target database systems.

Clause 12. The method of any of the preceding clauses 9 to 11, wherein the version control system is remotely connected to the source and target database systems and being closer to the target database system.

Clause 13. The method of any of the preceding clauses 2 to 12, further comprising undoing the change using the logfile and the version control system.

Clause 14. The method of any of the preceding clauses 1 to 13, further comprising: enabling access in the version control system to the whole value of the second column or to a selected portion of the value using a cursor that enables traversal of portions of the value, the access being a read access and/or write access.

Clause 15. The method of any of the preceding clauses 1 to 14, wherein the second column is tagged to indicate that it comprises second type data, the database system comprising a configurable parameter indicating the second type data, the method further comprising: receiving a request to create the table; determining that a column of the table has values of the second type data in accordance with the configurable parameter; creating the table with the second column of the table being tagged; wherein the method is performed in response to determining that the table is tagged.

Computing environment 1800 contains an example of an environment for the execution of at least some of the computer code involved in performing the disclosed methods, such as a table storage code 1900. In addition to block 1900, computing environment 1800 includes, for example, computer 1801, wide area network (WAN) 1802, end user device (EUD) 1803, remote server 1804, public cloud 1805, and private cloud 1806. In this embodiment, computer 1801 includes processor set 1810 (including processing circuitry 1820 and cache 1821), communication fabric 1811, volatile memory 1812, persistent storage 1813 (including operating system 1822 and block 1900, as identified above), peripheral device set 1814 (including user interface (UI) device set 1823, storage 1824, and Internet of Things (IoT) sensor set 1825), and network module 1815. Remote server 1804 includes remote database 1830. Public cloud 1805 includes gateway 1840, cloud orchestration module 1841, host physical machine set 1842, virtual machine set 1843, and container set 1844.

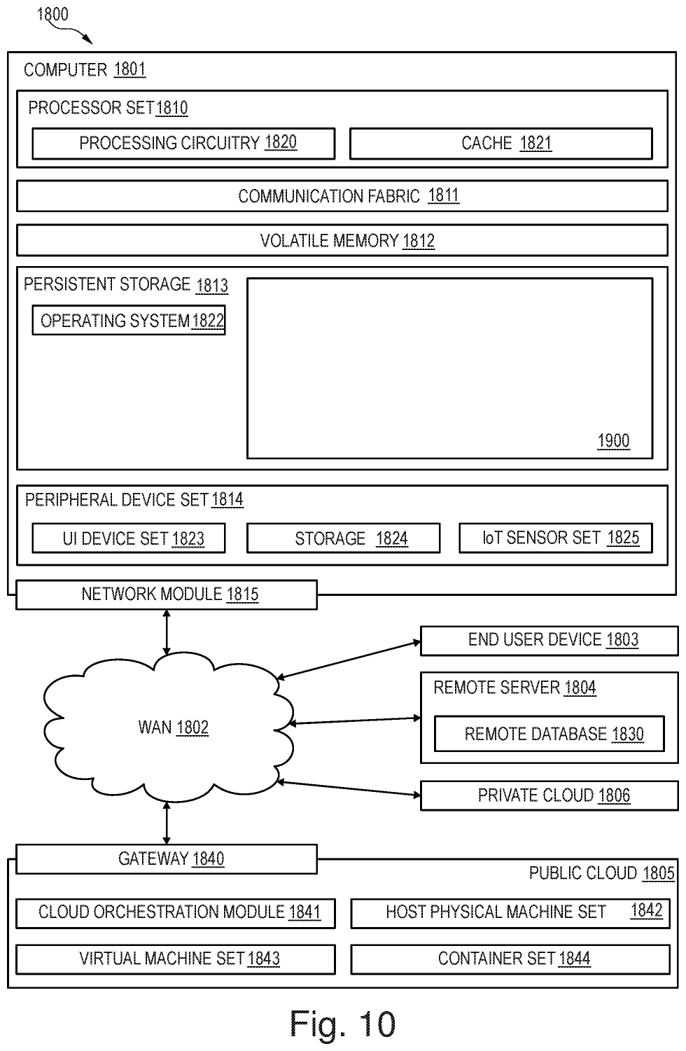

COMPUTER 1801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1830. As is well understood in the art of computer technology, and depending upon the technology, performance of a computer-implemented method may be distributed among multiple computers and/or between multiple locations. On the other hand, in this presentation of computing environment 1800, detailed discussion is focused on a single computer, specifically computer 1801, to keep the presentation as simple as possible. Computer 1801 may be located in a cloud, even though it is not shown in a cloud in FIG. 10. On the other hand, computer 1801 is not required to be in a cloud except to any extent as may be affirmatively indicated.

PROCESSOR SET 1810 includes one, or more, computer processors of any type now known or to be developed in the future. Processing circuitry 1820 may be distributed over multiple packages, for example, multiple, coordinated integrated circuit chips. Processing circuitry 1820 may implement multiple processor threads and/or multiple processor cores. Cache 1821 is memory that is located in the processor chip package(s) and is typically used for data or code that should be available for rapid access by the threads or cores running on processor set 1810. Cache memories are typically organized into multiple levels depending upon relative proximity to the processing circuitry. Alternatively, some, or all, of the cache for the processor set may be located “off chip.” In some computing environments, processor set 1810 may be designed for working with qubits and performing quantum computing.

Computer readable program instructions are typically loaded onto computer 1801 to cause a series of operational steps to be performed by processor set 1810 of computer 1801 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 1821 and the other storage media discussed below. The program instructions, and associated data, are accessed by processor set 1810 to control and direct performance of the disclosed methods. In computing environment 1800, at least some of the instructions for performing the disclosed methods may be stored in block 1900 in persistent storage 1813.

COMMUNICATION FABRIC 1811 is the signal conduction path that allows the various components of computer 1801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1812 is any type of volatile memory now known or to be developed in the future. Examples include dynamic type random access memory (RAM) or static type RAM. Typically, volatile memory 1812 is characterized by random access, but this is not required unless affirmatively indicated. In computer 1801, the volatile memory 1812 is located in a single package and is internal to computer 1801, but, alternatively or additionally, the volatile memory may be distributed over multiple packages and/or located externally with respect to computer 1801.

PERSISTENT STORAGE 1813 is any form of non-volatile storage for computers that is now known or to be developed in the future. The non-volatility of this storage means that the stored data is maintained regardless of whether power is being supplied to computer 1801 and/or directly to persistent storage 1813. Persistent storage 1813 may be a read only memory (ROM), but typically at least a portion of the persistent storage allows writing of data, deletion of data and re-writing of data. Some familiar forms of persistent storage include magnetic disks and solid state storage devices. Operating system 1822 may take several forms, such as various known proprietary operating systems or open source Portable Operating System Interface-type operating systems that employ a kernel. The code included in block 1900 typically includes at least some of the computer code involved in performing the disclosed methods.

PERIPHERAL DEVICE SET 1814 includes the set of peripheral devices of computer 1801. Data communication connections between the peripheral devices and the other components of computer 1801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1823 may include components such as a display screen, speaker, microphone, wearable devices (such as goggles and smart watches), keyboard, mouse, printer, touchpad, game controllers, and haptic devices. Storage 1824 is external storage, such as an external hard drive, or insertable storage, such as an SD card. Storage 1824 may be persistent and/or volatile. In some embodiments, storage 1824 may take the form of a quantum computing storage device for storing data in the form of qubits. In embodiments where computer 1801 is required to have a large amount of storage (for example, where computer 1801 locally stores and manages a large database) then this storage may be provided by peripheral storage devices designed for storing very large amounts of data, such as a storage area network (SAN) that is shared by multiple, geographically distributed computers. IoT sensor set 1825 is made up of sensors that can be used in Internet of Things applications. For example, one sensor may be a thermometer and another sensor may be a motion detector.

NETWORK MODULE 1815 is the collection of computer software, hardware, and firmware that allows computer 1801 to communicate with other computers through WAN 1802. Network module 1815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1815 are performed on the same physical hardware device. In other embodiments (for example, embodiments that utilize software-defined networking (SDN)), the control functions and the forwarding functions of network module 1815 are performed on physically separate devices, such that the control functions manage several different network hardware devices. Computer readable program instructions for performing the disclosed methods can typically be downloaded to computer 1801 from an external computer or external storage device through a network adapter card or network interface included in network module 1815.

WAN 1802 is any wide area network (for example, the internet) capable of communicating computer data over non-local distances by any technology for communicating computer data, now known or to be developed in the future. In some embodiments, the WAN 1802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1803 is any computer system that is used and controlled by an end user (for example, a customer of an enterprise that operates computer 1801), and may take any of the forms discussed above in connection with computer 1801. EUD 1803 typically receives helpful and useful data from the operations of computer 1801. For example, in a hypothetical case where computer 1801 is designed to provide a recommendation to an end user, this recommendation would typically be communicated from network module 1815 of computer 1801 through WAN 1802 to EUD 1803. In this way, EUD 1803 can display, or otherwise present, the recommendation to an end user. In some embodiments, EUD 1803 may be a client device, such as thin client, heavy client, mainframe computer, desktop computer and so on.

REMOTE SERVER 1804 is any computer system that serves at least some data and/or functionality to computer 1801. Remote server 1804 may be controlled and used by the same entity that operates computer 1801. Remote server 1804 represents the machine(s) that collect and store helpful and useful data for use by other computers, such as computer 1801. For example, in a hypothetical case where computer 1801 is designed and programmed to provide a recommendation based on historical data, then this historical data may be provided to computer 1801 from remote database 1830 of remote server 1804.

PUBLIC CLOUD 1805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1805 is performed by the computer hardware and/or software of cloud orchestration module 1841. The computing resources provided by public cloud 1805 are typically implemented by virtual computing environments that run on various computers making up the computers of host physical machine set 1842, which is the universe of physical computers in and/or available to public cloud 1805. The virtual computing environments (VCEs) typically take the form of virtual machines from virtual machine set 1843 and/or containers from container set 1844. It is understood that these VCEs may be stored as images and may be transferred among and between the various physical machine hosts, either as images or after instantiation of the VCE. Cloud orchestration module 1841 manages the transfer and storage of images, deploys new instantiations of VCEs and manages active instantiations of VCE deployments. Gateway 1840 is the collection of computer software, hardware, and firmware that allows public cloud 1805 to communicate through WAN 1802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer. such as connected devices, files and folders, network shares, CPU power, and quantifiable hardware capabilities. However, programs running inside a container can only use the contents of the container and devices assigned to the container, a feature which is known as containerization.

PRIVATE CLOUD 1806 is similar to public cloud 1805, except that the computing resources are only available for use by a single enterprise. While private cloud 1806 is depicted as being in communication with WAN 1802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1805 and private cloud 1806 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

1. A method for storing data, the method comprising:
providing a database system with a table being configured to store data, the table comprising a first column and a second column, the first column being configured to comprising a first type of data, the second column being configured to comprising a second type of data, wherein the second type of data has a maximum size higher than a maximum size of the first type of data;
providing a version control system;
receiving a first query to store a first record in the table;
determining whether the first record comprises a first value of the second column;
storing the first value in the version control system in response to determining that the first record comprises the first value of the second column;
obtaining a reference token representing the first value in response to determining that the first record comprises the first value of the second column;
storing the reference token in the second column of the table;
receiving a second query to store a second record in the table;
determining whether the second record comprises a second value of the second column; and
storing the second record in the table in response to determining that the second record does not comprise the second value of the second column.

2. The method of claim 1, the version control system being configured to maintain different versions of the second column, wherein the reference token represents a specific version of the first value of the second column in the first record, the method further comprising:
creating a logfile for logging changes of the table, wherein:
a log entry is created in the logfile to represent a change involving at least one given record of the table, the log entry comprising a value of the first column of the at least one given record and/or the reference token of the first value of the second column of the at least one given record; and
the at least one given record being a deleted record and/or an inserted record.

3. The method of claim 2, further comprising:
reading the log entry; and
finding the reference token in preparation to undo the change.

4. The method of claim 1, wherein the database system is configured to manage data in the table using a command processor, wherein the first query is destined to the command processor, wherein the receiving of the first query comprises intercepting the first query by a handler of the database system; wherein the handler is configured to perform:
the determining whether the first record comprises the first value of the second column; and the storing the first value in the version control system;
the obtaining of the reference token from the version control system;
changing the first query to replace the first value of the second column by the reference token; and
forwarding the first query to the command processor for execution of the first query against the table.

5. The method of claim 1, the database system is configured to manage data in the table using a command processor, the method further comprising:
intercepting, by a handler, of the database system a read request of a third value of the second column, the read request being destined to the command processor;
preventing, by the handler, the command processor to return the reference token associated the third value;
returning, by the handler, the third value from the version control system.

6. The method of claim 1, wherein the received first query is a request to insert the first record in the table or a request to update another record of the table by the first record.

7. The method of claim 1, further comprising:
receiving a read request to read the table;
identifying reference tokens of the table that satisfy the read request;
providing values in the version control system which are associated with the identified reference tokens; and
providing values of the first column that satisfy the read request from the table.

8. The method of claim 1, further comprising:
receiving a delete request to delete a third value of the second column;
deleting from the table the reference token that represents the third value to be deleted; and
deleting the third value of the second column from the version control system in response to a deletion condition being fulfilled.

9. The method of claim 8, wherein the deletion condition requires that queries referencing the reference token that represents the third value to be deleted are ended.

10. The method of claim 1, the database system being a source database system of a data analysis system, the data analysis system comprising a target database system, wherein the target database system comprises a target table that provides a replication copy of the table, the method further comprising:
synchronizing the table with the target table such that the target table comprises records of the table, wherein a record of the target table comprises the reference token and the value of the first column.

11. The method of claim 10, wherein the target database system further comprises a target handler, the target handler being configured for:
intercepting a third query referencing the target table;
identifying the reference tokens of the target table that satisfy the third query;
providing values in the version control system which are associated with the identified reference tokens;
providing values of the first column that satisfy the third query from the target table.

12. The method of claim 10, wherein the version control system is remotely connected to the source and target database systems.

13. The method of claim 10, wherein the version control system is remotely connected to the source and target database systems and is closer to the target database system.

14. The method of claim 1, further comprising: enabling access in the version control system to the whole value of the second column or to a selected portion of the whole value of the second column using a cursor that enables traversal of portions of the whole value, the access being a read access and/or a write access.

15. The method of claim 1, wherein the second column is tagged to indicate that it comprises the second type of data, the database system comprising a configurable parameter indicating the second type of data, the method further comprising:
receiving a request to create the table;
determining that a column of the table has values of the second type of data in accordance with the configurable parameter;
creating the table with the second column of the table being tagged;
wherein the method is performed in response to determining that the table is tagged.

16. A computer program product for storing data in a database system, the computer program product comprising:
one or more computer-readable storage media, and program instructions collectively stored one the one or more computer readable storage media, the program instructions comprising:
program instructions to provide a database system with a table being configured to store data, the table comprising a first column and a second column, the first column being configured to comprising a first type of data, the second column being configured to comprising a second type of data, wherein the second type of data has a maximum size higher than a maximum size of the first type of data;
program instructions to provide a version control system;
program instructions to receive a first query to store a first record in the table;
program instructions to determine whether the first record comprises a first value of the second column;
program instructions to store the first value in the version control system in response to determining that the first record comprises the first value of the second column;
program instructions to obtain a reference token representing the first value in response to determining that the first record comprises the first value of the second column;
program instructions to store the reference token in the second column of the table;
program instructions to receive a second query to store a second record in the table;
program instructions to determine whether the second record comprises a second value of the second column; and
program instructions to store the second record in the table in response to determining that the second record does not comprise the second value of the second column.

17. A database system for storing data comprising:
a table comprising a first column and a second column, the first column being configured for comprising first type data, the second column being configured for comprising second type data, wherein the second type data has a maximum size higher than a maximum size of the first type data;
a memory, the memory containing one or more instructions; and
a processor, the processor communicatively coupled to the memory, the processor, in response to reading the one or more instructions, configured to:
receive a first query to store a first record in the table;
determine whether the first record comprises a first value of the second column;
store the first value in a version control system in response to the first record comprising the first value of the second column;
obtain a reference token representing the first value in response to the first record comprising the first value of the second column;
store the reference token in the second column of the table;
receive a second query to store a second record in the table;
determine whether the second record comprises a second value of the second column; and
store the second record in the table in response to the second record not comprising the second value of the second column.

18. The database system of claim 17, wherein the version control system is configured to maintain different versions of the second column, wherein the reference token represents a specific version of the first value of the second column in the first record, wherein the processor, in response to reading the one or more instructions, is further configured to:
create a logfile for logging changes of the table, wherein:
a log entry is created in the logfile to represent a change involving at least one given record of the table, the log entry comprising a value of the first column of the at least one given record and/or the reference token of the first value of the second column of the at least one given record; and
the at least one given record being a deleted record and/or an inserted record.

19. The database system of claim 17, wherein the received first query is a request to insert the first record in the table or a request to update another record of the table by the first record.

20. The database system of claim 17, wherein the processor, in response to reading the one or more instructions, is further configured to:
receiving a read request to read the table;
identifying reference tokens of the table that satisfy the read request;
providing values in the version control system which are associated with the identified reference tokens; and
providing values of the first column that satisfy the read request from the table.
